(19) United States
(12) Patent Application Publication
(10) Pub. No.: US 2012/0306740 A1
(43) Pub. Date: Dec. 6, 2012

(54) INFORMATION INPUT DEVICE USING VIRTUAL ITEM, CONTROL METHOD THEREFOR, AND STORAGE MEDIUM STORING CONTROL PROGRAM THEREFOR

(75) Inventor: Saori Hoda, Tokyo (JP)

(73) Assignee: CANON KABUSHIKI KAISHA, Tokyo (JP)

(21) Appl. No.: 13/477,799

(22) Filed: May 22, 2012

(30) Foreign Application Priority Data
May 30, 2011 (JP) 2011-120342

(51) Int. Cl. G09G 5/00

(52) U.S. Cl. 345/156

(57) ABSTRACT

An information input device that enables a user to input information easily by a single hand. The information input device inputs information using a virtual item displayed on a display unit. An image pickup unit shoots an indicator that operates the virtual item continuously to obtain indicator image data. A display control unit displays an indicator image corresponding to the indicator image data on the display unit. A setting unit sets, when detecting an action of the indicator to an element included in the virtual item displayed on the display unit, information corresponding to the element concerned as input information.

### BACKGROUND OF THE INVENTION

1. Field of the Invention

The present invention relates to an information input device using a virtual item, a control method therefore, and a storage medium storing a control program therefor. Particularly, the present invention relates to a character input method using a virtual item like a virtual keyboard.

2. Description of the Related Art

There are user's needs to coordinate image files of still and moving images captured on image pickup apparatuses, such as a digital camera and a digital video camera. When coordinating image files, a user may create a new folder and input a folder name, may change a filename, and may attach a memo to an image file. In this time, it is necessary to input characters.

However, image pickup apparatuses, such digital cameras, have small display screens (for example, liquid crystal displays). Therefore, when all the characters inputted are displayed in a display screen, each character becomes so small that a user cannot see well and cannot input characters easily.

Since a digital camera is merely provided with a few button, a cross key, a decision button, etc. as operating members, an operation becomes too complicated to input characters by these operating members.

On the other hand, there is a technique that projects a capsule image displaying a retrieval index in an image space by a stereoscopic vision device, manipulate the capsule image by a hand of a virtual arm directly, and recognizes input information (an input operation) based on an operation pattern of the hand (see Japanese Laid-Open Patent Publication (Kokai) No. H5-189484 (JP H5-189484A)).

There is a technique that displays a virtual keyboard close to a user's hand in a personal computer (referred to as a PC, hereafter) etc., detects a touched position in the virtual keyboard, and determines an input character corresponding to the detected touched position (see Japanese Laid-Open Patent Publication (Kokai) No. 2007-156548 (JP 2007-156548A)). This technique enables to select the display pattern of the virtual keyboard from among a plurality of patterns.

Moreover, there is a technique that a three-dimensional window unit displays a plurality of windows as translucent patterns so that relatively lower windows among overlapped windows are displayed by downsizing using a perspective view (see Japanese Laid-Open Patent Publication (Kokai) No. 2003-271279 (JP 2003-271279A)). In this technique, the position information about a cursor and a translucent window contains depth information, and movement information that shows a movement of the cursor or the translucent window with respect to a translucent-window screen in directions including a virtual vertical direction is calculated according to an input operation from an input device, and the cursor or the translucent window is displayed in a state shown by the movement information.

However, since JP H5-189484A requires special devices like goggles for displaying virtual space in three dimensions and a glove for selecting a capsule image, the input operation becomes rather troublesome for a user.

Since JP 2007-156548A supposes a keyboard used with a PC etc., a flat surface is needed in order to project a keyboard.

In JP 2003-271279A, even if a translucent window is selected, the translucent window concerned does not appear in the front side. Therefore, when the translucent window located in the back side becomes active, an inactive translucent window located at the front side obstructs a view of the active translucent window located in the back side. Then, it is necessary to adjust a viewpoint in order to see the translucent window located in the back side.

### SUMMARY OF THE INVENTION

The present invention provides an information input device, a control method therefor, and a storage medium storing a control program therefor, which enable a user to input information easily by a single hand.

Accordingly, a first aspect of the present invention provides an information input device for inputting information using a virtual item displayed on a display unit, comprising an image pickup unit configured to shoot an indicator that operates the virtual item continuously to obtain indicator image data, a display control unit configured to display an indicator image corresponding to the indicator image data on the display unit, and a setting unit configured to set, when detecting an action of the indicator to an element included in the virtual item displayed on the display unit, information corresponding to the element concerned as input information.

Accordingly, a second aspect of the present invention provides a control method for an information input device for inputting information using a virtual item displayed on a display unit, the control method comprising a shooting step of shooting an indicator that operates the virtual item continuously by an image pickup unit to obtain indicator image data, a display control step of displaying an indicator image corresponding to the indicator image data on the display unit, and a setting step of setting, when detecting an action of the indicator to an element included in the virtual item displayed on the display unit, information corresponding to the element concerned as input information.

Accordingly, a third aspect of the present invention provides a non-transitory computer-readable storage medium storing a control program causing a computer to execute the control method of the second aspect.

According to the present invention, the user is able to input characters easily by a single hand when inputting information using the virtual item.

Further features of the present invention will become apparent from the following description of exemplary embodiments with reference to the attached drawings.

### BRIEF DESCRIPTION OF THE DRAWINGS

FIG. 1 is a perspective view showing an external appearance of a camera with which an information input device according to an embodiment of the present invention is used when viewed from a back side.

FIG. 2 is a block diagram schematically showing a configuration example of the camera shown in FIG. 1.

FIG. 3 is a perspective view schematically showing a virtual desktop used with the camera shown in FIG. 1.

FIG. 4A is a view showing a hiragana input virtual keyboard as an example of the virtual keyboard shown in FIG. 3.

FIG. 4B is a view showing an uppercase alphanumeric character input virtual keyboard as an example of the virtual keyboard shown in FIG. 3.

FIG. 4C is a view showing a lowercase alphanumeric character input virtual keyboard as an example of the virtual keyboard shown in FIG. 3.

FIG. 4D is a view showing a PC-layout virtual keyboard as an example of the virtual keyboard shown in FIG. 3.

FIG. 5A, FIG. 5B, and FIG. 5C are views showing hand forms for moving a display area of the virtual keyboard shown in FIG. 3.

FIG. 6 is a flowchart showing a character input process with the virtual keyboard shown in FIG. 3.

FIG. 7 is a view showing an example of a hand and a gage displayed on a display unit according to the process shown in FIG. 6.

FIG. 8A is a view showing a partial display of the hiragana input virtual keyboard displayed on the display unit shown in FIG. 3.

FIG. 8B is a view showing a partial display of the uppercase alphanumeric character input virtual keyboard displayed on the display unit shown in FIG. 3.

FIG. 8C is a view showing a partial display of the lowercase alphanumeric character input virtual keyboard displayed on the display unit shown in FIG. 3.

FIG. 8D is a view showing an overlapping display of the hiragana input virtual keyboard and the uppercase alphanumeric character input virtual keyboard displayed on the display unit shown in FIG. 3.

FIG. 8E is a view showing an overlapping display of the uppercase alphanumeric character input virtual keyboard and the lowercase alphanumeric character input virtual keyboard displayed on the display unit shown in FIG. 3.

FIG. 9 is a view showing a relation between a hand position and a change of the virtual keyboard shown in FIG. 3.

FIG. 10A is a view showing the state where the character is selected in the virtual keyboard shown in FIG. 3.

FIG. 10B is a view showing the state where the character is decided in the virtual keyboard shown in FIG. 3.

FIG. 11 is a view showing a conversion of characters in an editing area displayed on the display unit shown in FIG. 3.

### DESCRIPTION OF THE EMBODIMENTS

Hereafter, embodiments according to the present invention will be described in detail with reference to the drawings.

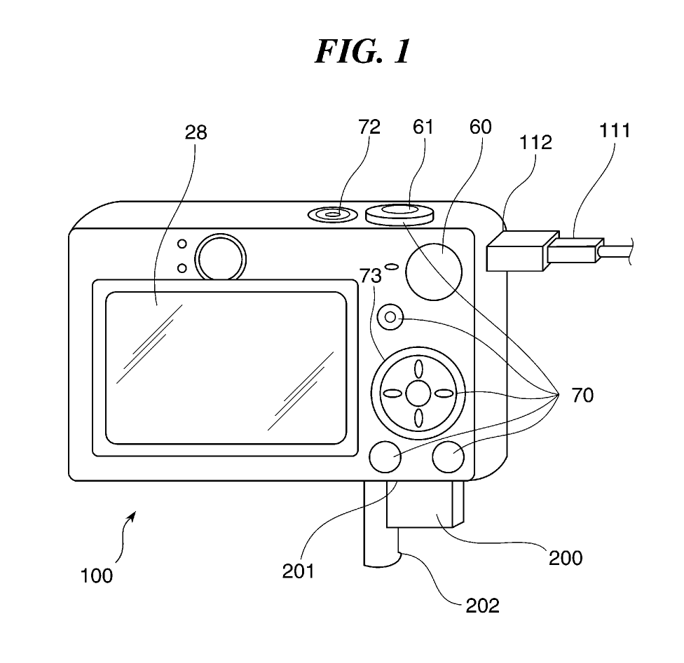

FIG. 1 is a perspective view showing an external appearance of a digital camera 100 with which an information input device according to the embodiment of the present invention is used when viewed from a back side. It should be noted that a character input device that is one of the information input devices will be described below.

The digital camera (referred to as a camera, hereafter) 100 has a display unit 28 on its back side. The display unit 28 displays images and various kinds of information. A shutter button 61 and a power switch 72 are arranged on an upper surface of the camera 100. A user turns on or off the power supply of the camera by an operation of the power switch 72, and instructs shooting by an operation of the shutter button 61.

At the right side of the display unit 28, a mode change switch 60 and a part of operating members 70 are arranged. It should be noted that the shutter button 61 is also one of the operating members 70. The user changes the mode of the camera 100 by operating the mode change switch 60. The operating members 70 includes various switches, buttons, and a touch panel, etc. for receiving various input operations by the user, and also includes a controller wheel 73. The controller wheel 73 permits a rotary operation.

A connector 112 is arranged in one side of the camera 100. A connecting cable 111 that connects the camera 100 with an external apparatus like a PC (not shown) is connectable to the connector 112. A storage medium slot 201 for inserting a storage medium 200 is formed in the undersurface of the camera 100. A memory card is used as the storage medium 200, for example. The storage medium 200 becomes communicatable with the camera when being inserted into the storage medium slot 201. It should be noted that a cover 202 will be closed after inserting the storage medium 200 into the storage medium slot 201.

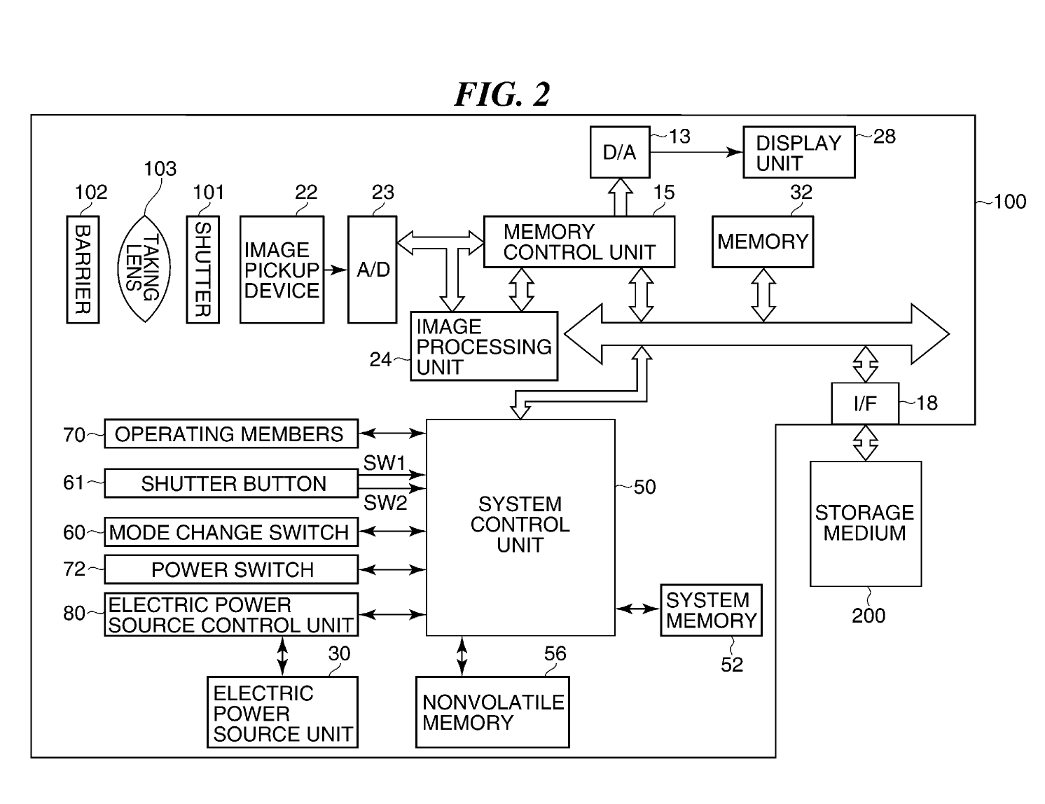

FIG. 2 is a block diagram schematically showing a configuration example of the camera 100 shown in FIG. 1.

In FIG. 2, the camera 100 has a taking lens 103 including a focus lens and a shutter 101 provided with a diaphragm function. An object light passing through the taking lens 103 and the shutter 101 forms an image on an image pickup unit 22. The image pickup unit 22 is a CCD or VMOS image pickup device, which converts an optical image into an electrical signal (analog signal). Then, an A/D converter 23 converts the analog signal into a digital signal (image signal). Except the time of shooting, the taking lens 103 is covered by a barrier 102 so as to prevent the lens from soiling and breaking.

An image processing unit 24 applies a resizing process (predetermined pixel interpolation, reduction, etc.) and a color conversion process to the image signal outputted from the A/D converter 23 or to image data given from a memory control unit 15. The image processing unit 24 performs a predetermined calculation process using the image data, and a system control unit 50 performs an exposure control and a distance measuring control based on the calculation result. According to these controls, an AF (auto-focusing) process of a TTL (through the lens) system, an AE (automatic exposure) process, and an EF (pre-emission of flash) process are executed. The image processing unit 24 performs a predetermined calculation process using the image data, and performs an AWB (automatic white balance) process of the TTL system based on the calculation result.

The image signal outputted from the A/D converter 23 is written into a memory 32 via the image processing unit 24 and the memory control unit 15 or is directly written into the memory via the memory control unit 15 as the image data. The memory 32 has sufficient memory capacity for storing still images of the predetermined number, moving images of predetermined time, and voice data. In the illustrated example, the memory 32 also serves as a memory for image display (a video memory).

A D/A converter 13 converts the image data stored in the memory 32 into an analog signal, and gives it to the display unit 28. Accordingly, the image data written in the memory 32 is displayed on the display unit 28 as an image.

A nonvolatile memory 56 is a memory, such as an EEPROM, which is able to erase and record electrically. The nonvolatile memory 56 stores constants, programs, etc. for the operation of the system control unit 50. The programs include a program to execute a flowchart mentioned later, for example.

The system control unit 50 controls the whole camera 100. The system control unit 50 executes the programs recorded in the nonvolatile memory 56 to perform the processes mentioned later. A system memory 52 employs a RAM, for example. The constants and variables for the operation of the system control unit 50 and the programs read from the nonvolatile memory 56 will be developed to the system memory 52. The system control unit 50 controls the memory 32, the D/A converter 13, the display unit 28, etc. to control a screen display.

The shutter button 61 is provided with first and second shutter switches, and operation instructions are inputted into the system control unit 50 by operation of the shutter button 61. The first shutter switch turns ON when the shutter button 61 is depressed in half of the stroke (a preparation instruction), and outputs a first shutter switch signal SW1. The first shutter switch signal SW1 starts the AF process, the AE process, the AWB process, and the EF process, etc.

The second shutter switch turns ON when the shutter button 61 is fully depressed (a shooting instruction), and outputs a second shutter switch signal SW2. The system control unit 50 starts a series of shooting processes from a reading of signal of the image pickup unit 22 until a writing of image data into the storage medium 200 in response to the second shutter switch signal SW2.

The mode change switch 60 selects the operation mode of the system control unit 50 from among a still image recording mode, a moving image recording mode, and a replay mode, etc.

When one of function icons displayed on the display unit 28 is selected, functions are assigned to the operating members 70, respectively, according to the selected icon, and the operating members 70 operate as various function buttons. There are an end button, a back button, a next image button, a jump button, a stop down button, and an attribute changing button, etc. as the function buttons. For example, when a menu button is depressed, a menu screen for performing various settings is displayed on the display unit 28. Then, the user can perform various settings intuitively using the menu screen displayed on the display unit 28, a four direction button arranged crosswise that is included in the operating members 70, and a SET button arranged at the center thereof.

The controller wheel 73 is used for instructing selections in cooperation with the four direction button.

An electric power source control unit 80 has a battery detection circuit, a DC-DC converter, a switching circuit, etc., for example. Then, the electric power source control unit 80 detects existence of a battery, a type of a battery, and battery residue. The electric power source control unit 80 controls the DC-DC converter based on the detection result and instructions from the system control unit 50, and supplies a required voltage to the respective units including the storage medium 200 during a required period.

An electric power source unit 30 has a primary battery like an alkaline battery or a lithium battery, a secondary battery like a NiCd battery, a NiMH battery, or a Li battery, and an AC adaptor, etc., for example. An interface 18 connects the storage medium 200 and the camera 100.

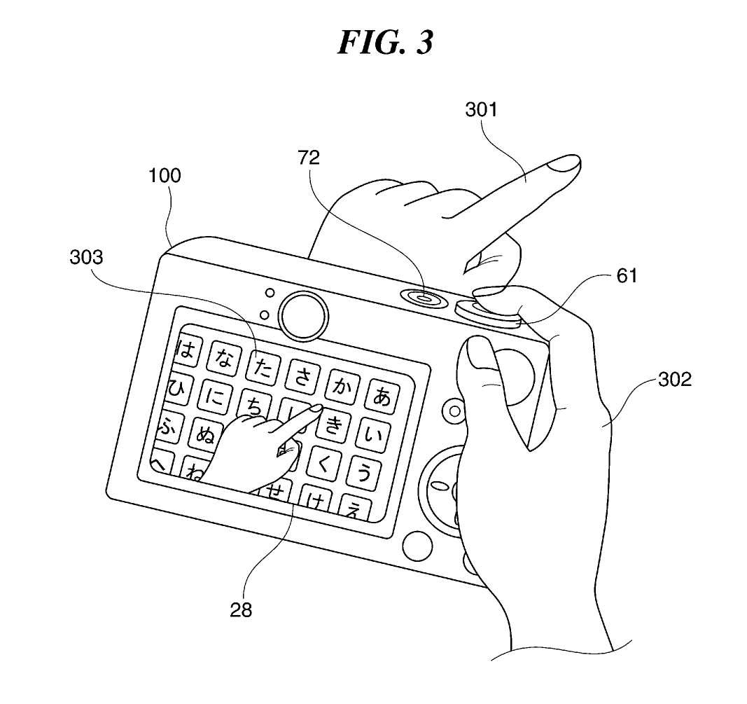

FIG. 3 is a perspective view schematically showing a virtual desktop used by the camera 100 shown in FIG. 1.

In FIG. 3, the virtual desktop means a user interface that links motions of an indicator like a hand and a virtual item in a virtual space to processes of moving, selecting, and determining the virtual item. In the illustrated example, a way of inputting a character is described assuming that a virtual keyboard is used as the virtual item in the virtual space and keys are used as elements of the virtual item.

The user grasps the camera 100 by a right hand 302, positions a left hand 301 in front of the taking lens 103, and shoots continuously to obtain the image data of the left hand as the indicator. Then, the system control unit 50 trims an indicator image data showing the left hand 301 from a background image of the image data, and displays the indicator image on the display unit 28. In this time, the virtual keyboard 303 is displayed at a lower side (i.e., a back side) of the image corresponding to the indicator image data (i.e., the left hand image) on the display unit 28. In the following description, the left hand image is also referred to as the left hand simply.

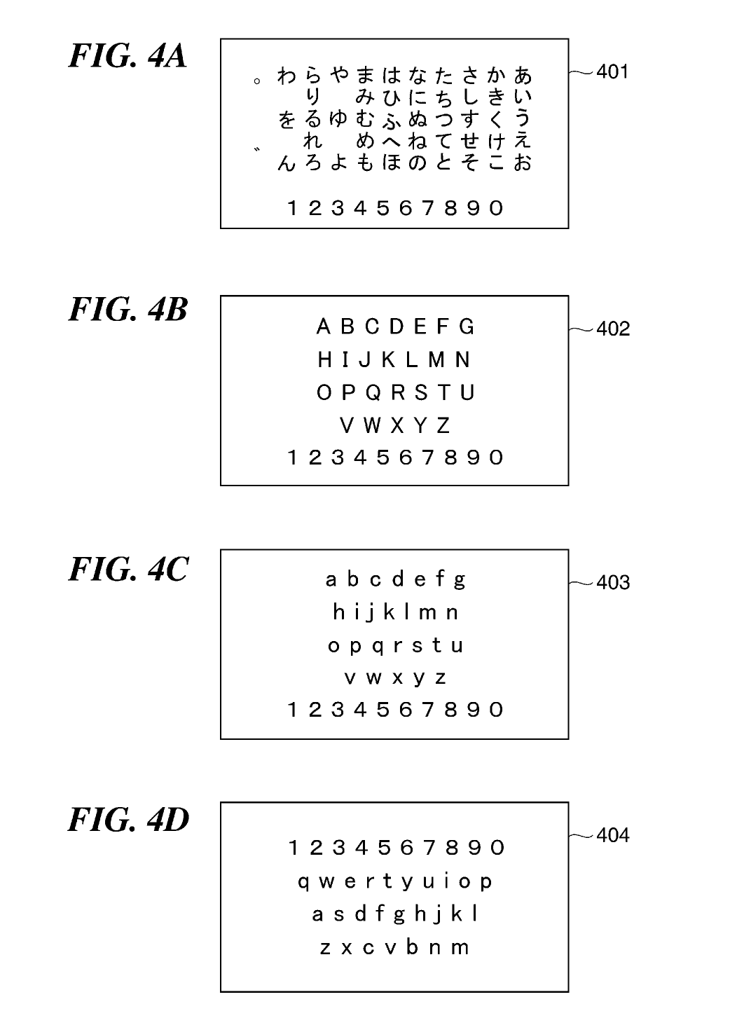

FIG. 4A through FIG. 4D are views showing examples of the virtual keyboard 303 shown in FIG. 3. FIG. 4A is a view showing a hiragana input virtual keyboard 401, and FIG. 4B is a view showing an uppercase alphanumeric character input virtual keyboard 402. FIG. 4C is a view showing a lowercase alphanumeric character input virtual keyboard 403, and FIG. 4D is a view showing a PC-layout virtual keyboard 404.

As shown in FIG. 4A through FIG. 4C, the hiragana input virtual keyboard 401, the uppercase alphanumeric character input virtual keyboard 402, or the lowercase alphanumeric character input virtual keyboard 403 is selectively used as the virtual keyboard 303 here, for example. It should be noted that the PC-layout virtual keyboard 404 that has a key layout of a keyboard used with a PC as shown in FIG. 4D may be used, and the virtual keyboard may include marks, pictorial symbols, etc. Although the three virtual keyboards shown in FIG. 4A through FIG. 4C are selectable to be used in the following description, the present invention is enough to use at least two virtual items (virtual keyboards).

In the example shown in FIG. 3, only some keys (elements) of the hiragana input virtual keyboard 401 shown in FIG. 4A are displayed on the display unit 28. When the direction of the camera 100 is changed, other keys are displayed.

Specifically, when the right hand 302 that is grasping the camera 100 is moved vertically and horizontally, a display area of the virtual keyboard 303 will move corresponding to the moving distance. Accordingly, the user is able to move the display area with feeling of shooting the fixed virtual keyboard 303 by the camera 100. When interlocking the camera 100 and the virtual keyboard 303, a method of presuming a direction and distance using a gyroscope is used, for example. Alternatively, a method of presuming a direction and distance by performing an inter-frame matching of a background subject may be used.

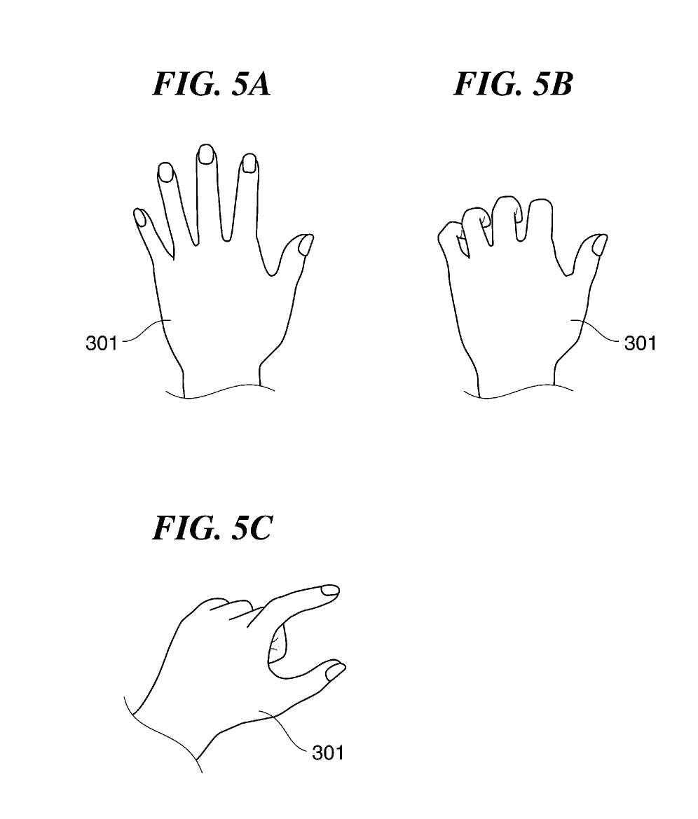

Another method of moving the display area of the virtual keyboard 303 will be described with reference to FIG. 5A, FIG. 5B, and FIG. 5C.

FIG. 5A, FIG. 5B, and FIG. 5C are views showing hand forms for moving the display area of the virtual keyboard 303 shown in FIG. 3.

It is assumed that the user moves the left hand 301 while bending the fingers as shown in FIG. 5B after expanding the five fingers of the left hand 301 as shown in FIG. 5A. The system control unit 50 shifts to a moving mode of the virtual keyboard 303 when determining that the five fingers of a human skin color shown in FIG. 5A are detected in the image data. Then, when the five fingers become short as shown in FIG. 5B, the system control unit 50 moves the virtual keyboard 303 in response to the direction and distance of the movement of the left hand 301. Accordingly, the user is able to move the display area with feeling of grasping and moving the virtual keyboard 303 by the left hand. For example, when detecting a hand form that picks a character by an index finger and a thumb of the left hand 301 as shown in FIG. 5C, the system control unit 50 serves as a character selection mode. In this case, the system control unit 50 detects the two fingers of the human skin color from the image data.

Although a part of the virtual keyboards 303 is displayed on the display unit 28 in the above description, the whole virtual keyboard 303 may be displayed on the display unit 28. In addition, although the example in FIG. 3 shows the case where the camera 100 is grasped by the right hand 302 and a character is inputted by the motion of the left hand 301, a character may be inputted by a motion of either of the right and left hands as long as the camera 100 is designed so as to be grasped by either of the right and left hands.

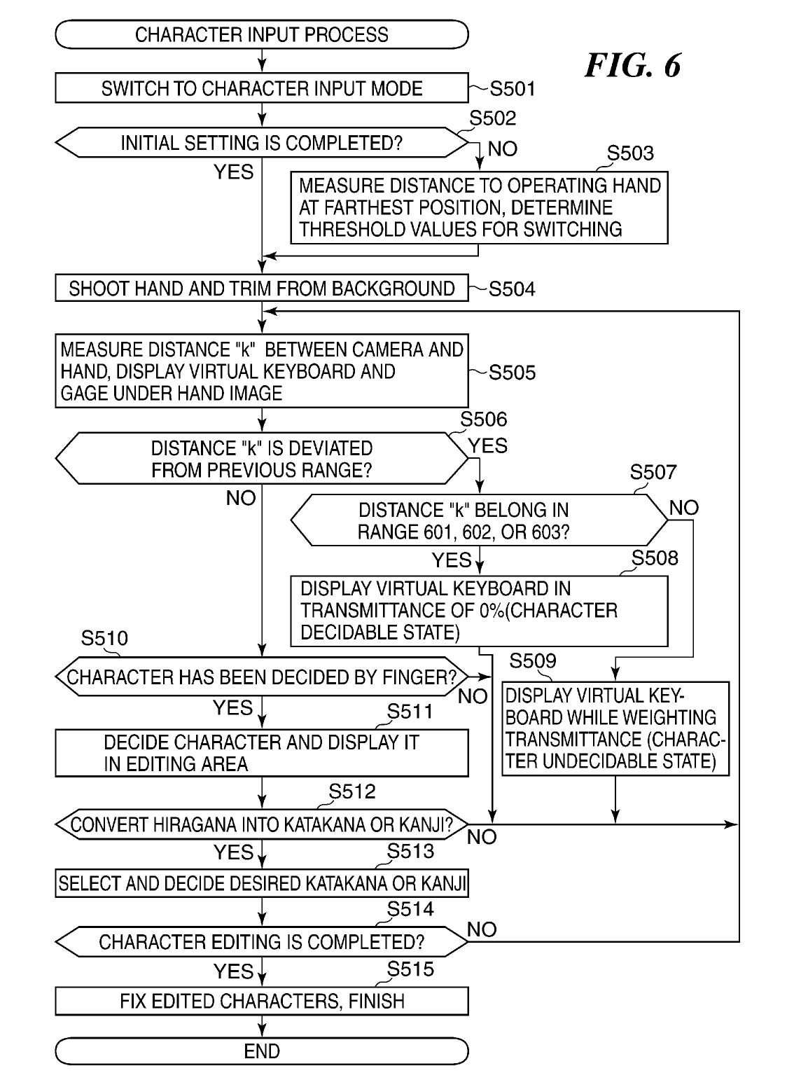

FIG. 6 is a flowchart showing a character input process with the virtual keyboard 303 shown in FIG. 3. It should be noted that the process shown in the illustrated flowchart is executed by the system control unit 50.

As shown in FIG. 6, when performing a character input process, the system control unit 50 switches the mode to a character input mode in response to an operation of the operation members 70 by the user (step S501). Here, the user changes a filename or fills a folder name of a newly created folder in the character input mode, for example.

Subsequently, the system control unit 50 checks whether an initial setting has been completed (step S502). Here, the initial setting means that a threshold value for switching the type of the virtual keyboard 303 displayed has been set up.

If the initial setting has not been completed (NO in the step S502), the system control unit 50 sets up the threshold value of a distance in consideration of a user's arm length (step S503). The user instructs the distance measurement while grasping the camera 100 by the right hand 302 and stretching out the left hand 301 to the farthest position that enables to input a character without inconvenience. Then, the system control unit 50 sets the threshold value so that the type of the virtual keyboard is changed at a convenient position for the user. At least one threshold value is set in the camera 100.

Thus, the threshold value is determined at the position of the left hand 301 that is convenient to switch the type of the virtual keyboard 303 for the user in the initial setting. It should be noted that the user may set the threshold value according to results of some tests that are beforehand prepared to the user.

When the initial setting has been completed (YES in the step S502), or when the initial setting has been performed in the step S503, the system control unit 50 shoots the left hand 301 and obtains image data. The system control unit 50 detects a human skin color in the image data, and trims a left hand image from a background according to the detection result (step S504).

When the skin color of the hand cannot be detected because the user wears a glove, the system control unit 50 may learn the color of the glove by shooting the left hand 301 several times while the user extends all the fingers of the left hand 301, for example.

Subsequently, the system control unit 50 measures the distance between the camera 100 and the left hand 301. For example, the distance between the camera 100 and the left hand 301 is acquired by measuring a gap of two images formed on a line sensor by separator lenses using phase difference AF. Alternatively, the distance between the camera 100 and the left hand 301 may be found in response to a time until a reflected wave returns from the left hand 301 that is irradiated with an infrared ray or an ultrasonic wave from the camera 100. Then, the system control unit 50 displays the virtual keyboard 303 and a gage under the left hand image (at the back side) on the display unit 28 (step S505).

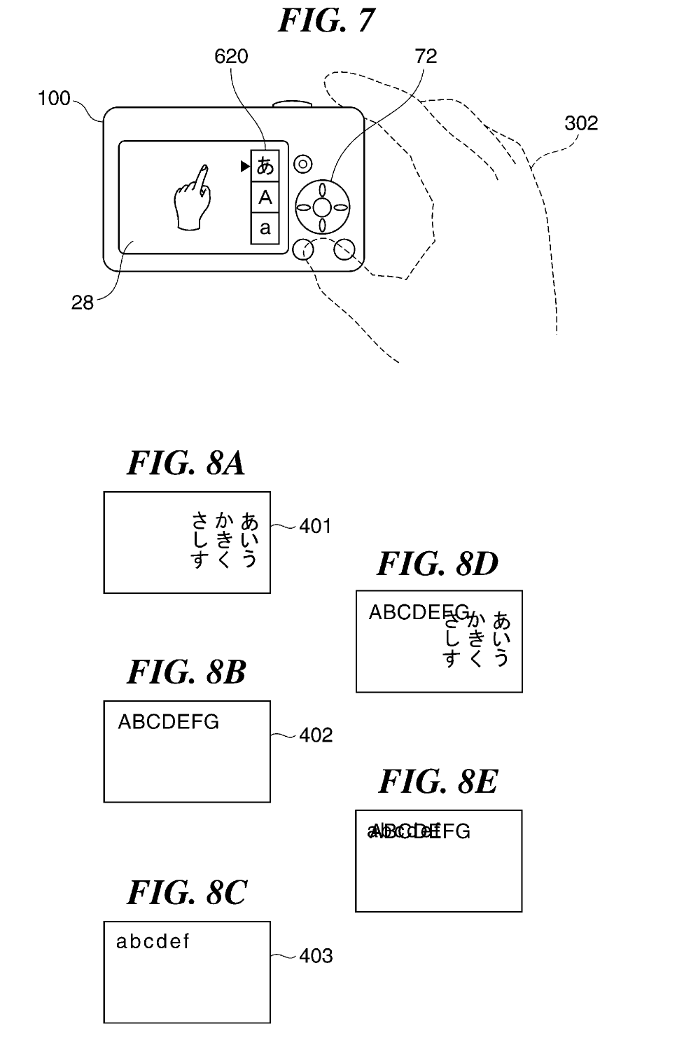

FIG. 7 is a view showing an example of the hand image and the gage displayed on the display unit 28 according to the process shown in FIG. 6.

The left hand image and the gage 620 are displayed on the display unit 28 by the process in the above-mentioned step S505. The gage 620 is located at the right side in the screen. It should be noted that the virtual keyboard 303 is omitted in FIG. 7.

FIG. 8A through FIG. 8E are views for describing the virtual keyboard 303 displayed on the display unit 28 shown in FIG. 3. FIG. 8A is a view showing a partial display of the hiragana input virtual keyboard. FIG. 8B is a view showing a partial display of the uppercase alphanumeric character input virtual keyboard. FIG. 8C is a view showing a partial display the lowercase alphanumeric character input virtual keyboard. FIG. 8D is a view showing an overlapping display of the hiragana input virtual keyboard and the uppercase alphanumeric character input virtual keyboard. FIG. 8E is a view showing an overlapping display of the uppercase alphanumeric character input virtual keyboard and the lowercase alphanumeric character input virtual keyboard.

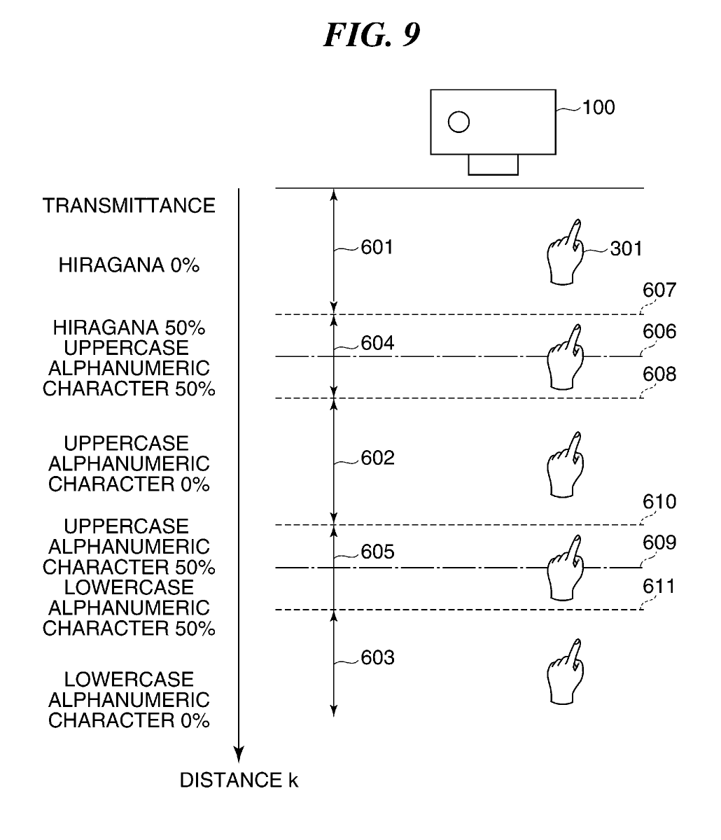

FIG. 9 is a view showing a relation between a hand position and a display change of the virtual keyboard 303 shown in FIG. 3.

As shown in FIG. 9, a plurality of area ranges 601 through 605 are recorded in the nonvolatile memory 56 in connection with the distance k from the camera 100 to the left hand 301. Each of references 606 and 609 shows the threshold value determined in the step S503. When the threshold values 606 and 609 are determined as mentioned above, the system control unit 50 records the threshold values 606 and 609 into the nonvolatile memory 56 in relation to the ranges 601 through 605.

It should be noted that the boundaries among the ranges 601 through 605 are called boundary threshold values in FIG. 9, and the threshold values determined by the initial setting are called set threshold values.

The system control unit 50 determines whether the distance k between the camera 100 and the left hand 301 was deviated from the range (area range) in which the distance detected at the previous distance measurement belonged, according to the image data taken continuously (step S506). For example, when the previously detected distance belonged in the range 601 and when the current distance k belongs in one of the ranges 602 through 605, the system control unit 50 determines that the left hand 301 moved out from the previous range in the direction that increases the distance k.

When determining that the distance k was deviated from the previous range (YES in the step S506), the system control unit 50 determines whether the left hand 301 moved to the range 601, 602, or 603 (step S507).

When the left hand 301 is located within the range 601, 602, or 603 (YES in the step S507), the system control unit 50 determines to be in a character decidable state and displays the virtual keyboard 303 on the display unit 28 in the transmittance of 0% (step S508).

In the process in the step S508, when the left hand 301 is located in the range 601, the system control unit 50 displays the hiragana input virtual keyboard 401 on the display unit 28 as shown in FIG. 8A, and shifts to the character decidable state.

When the left hand 301 is in the range 602, the system control unit 50 displays the uppercase alphanumeric character input virtual keyboard 402 on the display unit 28 as shown in FIG. 8B, and shifts to the character decidable state.

When the left hand 301 is in the range 603, the system control unit 50 displays the lowercase alphanumeric character input virtual keyboard 403 on the display unit 28 as shown in FIG. 8C, and shifts to the character decidable state.

On the other hand, when the left hand 301 is located in the range 604 or 605 (NO in the step S507), the system control unit 50 determines that there is a character undecidable state, and weights the transmittances of a plurality of virtual keyboards as mentioned later. Then, a plurality of virtual keyboards are displayed in overlapped fashion (step S509).

In the process in the step S508, when the left hand 301 is located in the range 604, the system control unit 50 displays the hiragana input virtual keyboard 401 and the uppercase alphanumeric character input virtual keyboard 402 on the display unit 28 in overlapped fashion while weighting as shown in FIG. 8D. Hereby, the system control unit 50 makes the user recognize intuitively that the virtual keyboard 303 is in a changing state. Then, the system control unit 50 shifts to the character undecidable state.

When the left hand 301 is in the range 605, the system control unit 50 displays the uppercase alphanumeric character input virtual keyboard 402 and the lowercase alphanumeric character input virtual keyboard 403 on the display unit 28 in overlapped fashion while weighting as shown in FIG. 8E. Then, the system control unit 50 shifts to the character undecidable state.

As shown in FIG. 9, in the range closer to the camera than the boundary threshold value 607, the transmittance of the hiragana input virtual keyboard 401 (one of the virtual items) is 0%, and the transmittance of the uppercase alphanumeric character input virtual keyboard 402 (the other of the virtual items) is 100% (non-display).

The transmittances vary with the movement of the left hand 301. And then, when the distance k becomes equal to the threshold value 606, the transmittance of the hiragana input virtual keyboard 401 and the transmittance of the uppercase alphanumeric character input virtual keyboard 402 become 50%.

In the boundary threshold value 608, the transmittance of the hiragana input virtual keyboard 401 becomes 100% (non-display), and the transmittance of the uppercase alphanumeric character input virtual keyboard 402 becomes 0%. Thus, in the range 605, the transmittance of the hiragana input virtual keyboard 401 increases gradually and the transmittance of the uppercase alphanumeric character input virtual keyboard 402 decreases gradually as the distance k between the left hand 301 and the camera 100 increases.

In the boundary threshold value 610, the transmittance of the uppercase alphanumeric character input virtual keyboard 402 becomes 0%, and the transmittance of the lowercase alphanumeric character input virtual keyboard 403 becomes 100% (non-display). Then, the transmittances vary gradually. When the distance k becomes equal to the set threshold value 609, the transmittance of the uppercase alphanumeric character input virtual keyboard 402 and the transmittance of the lowercase alphanumeric character input virtual keyboard 403 become 50%.

In the boundary threshold value 611, the transmittance of the uppercase alphanumeric character input virtual keyboard 402 becomes 100% (non-display), and the transmittance of the lowercase alphanumeric character input virtual keyboard 403 becomes 0%.

It should be noted that the transmittance may vary linearly or nonlinearly. The respective widths of the ranges 604 and 605 may be set up in a manufacturing stage or by a user so that the ranges 601, 602, and 603 do not become too narrow.

After displaying the virtual keyboard 303 on the display unit 28 as mentioned above, the system control unit 50 returns the process to the step S505.

When determining that the distance k to the left hand 301 does not deviate from the previous range (NO in the step S506), the system control unit 50 determines whether a character has been decided by an operation of a finger (step S510). That is, the system control unit 50 determines whether the character has been inputted (information has been inputted) through the virtual keyboard 303.

When a character has not been inputted (NO in the step S510), the system control unit 50 returns the process to the step 505. On the other hand, when a character input has been inputted (YES in the step S510), the system control unit 50 fixes the inputted character and displays the character concerned in an editing area as mentioned later (step S511).

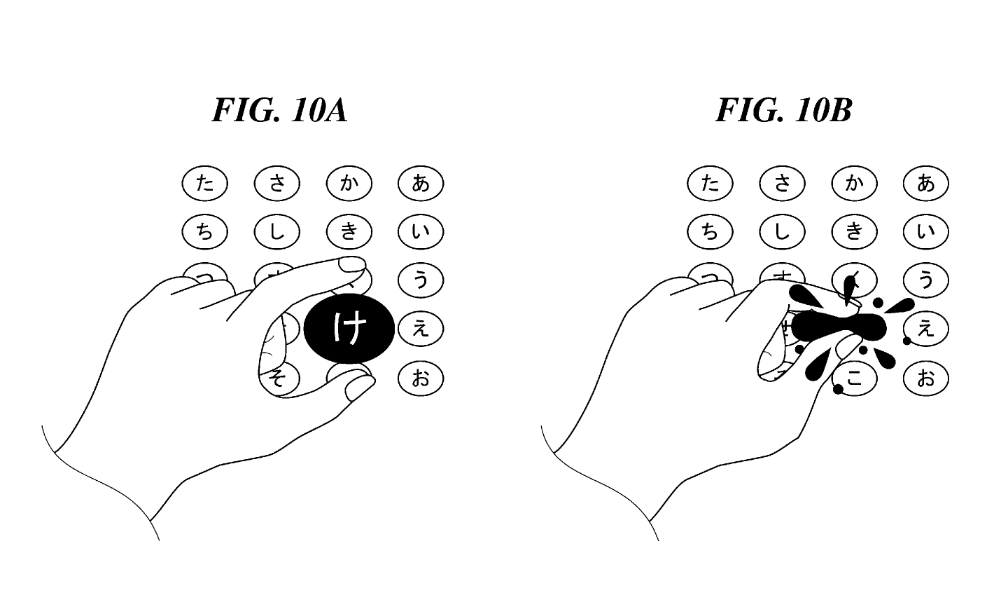

FIG. 10A and FIG. 10B are views for describing a selection and a decision of a character. FIG. 10A is a view showing the state where the character is selected. FIG. 10B is a view showing the state where the character is decided.

When the system control unit 50 recognizes that the left hand 301 behaves so as to pinch a character with the index finger and the thumb as shown in FIG. 5C based on the image data, the system control unit 50 shifts to a character selection mode. Here, as mentioned above, the system control unit 50 detects two fingers in the human skin color are detected from the image data, and detects that the character image is located between the index finger and the thumb of the left hand image.

In the example shown in FIG. 10A, a character “ke” in hiragana is selected by the two fingers. When the virtual item (virtual key) corresponding to the character is selected as shown in FIG. 10A in the character selection mode, the system control unit 50 varies the attribute of the selected character from the surrounding characters. Accordingly, the user can distinguish the selected character from unselected characters. In the illustrated example, the selected character under is emphasized by enlarging. It should be noted that a color of a selected character may be changed instead of enlarging.

When deciding the character, the user moves the fingers so as to crush the selected character as shown in FIG. 10B, for example. When recognizing the crushing action, the system control unit 50 decides the input of the selected character. When recognizing the crushing action, the system control unit 50 detects whether the two fingers in the human skin color contact each other or the two fingers form a circle based on the image data, and detects that the index finger and the thumb of the left hand image approach so that the distance becomes shorter than a predetermined value after the character image is located between the index finger and the thumb of the left hand image.

In this case, the system control unit 50 displays a graphic effect in which the character pinched with the fingers crushes and bursts on the display unit 28 in order to give a feeling of decision of the character to the user. It should be noted that the form of the left hand 301 and the graphic effect when a character is selected and decided are not limited to the illustrated example. For example, the system control unit 50 may become the character selection mode when detecting that the index finger of the left hand image overlaps the character image, and may decide the character when predetermined time elapses after the detection.

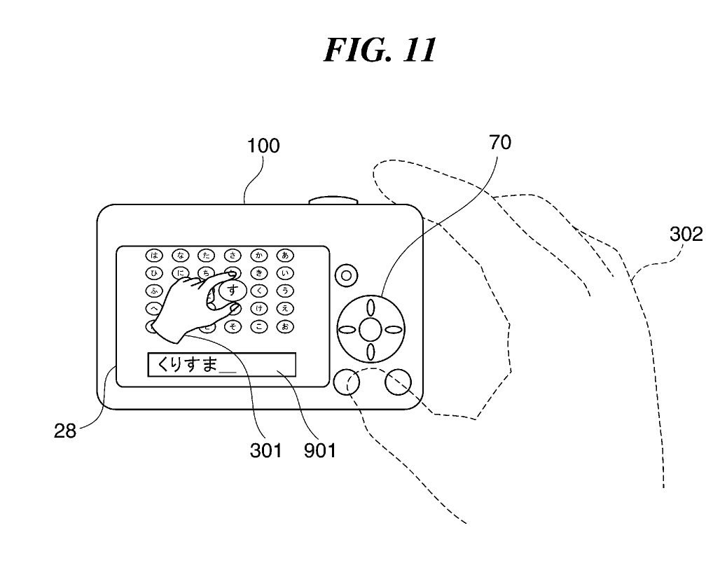

FIG. 11 is a view showing a conversion of characters in the editing area 901 displayed on the display unit 28 shown in FIG. 3.

The user is going to input the character string “ku-ri-su-ma-su” (it means “Christmas”) in hiragana using the virtual keyboard 303. As illustrated, the editing area 901 is displayed on the bottom of the display unit 28, and the character string “ku-ri-su-ma” is displayed on the editing area 901. Here is showing the state just before deciding the last character “su”.

In the above-mentioned step S511, when the user pinches and decides the character “su” of the virtual keyboard 303 with the fingers, the system control unit 50 displays “su” on the cursor position in the editing area 901.

Subsequently, the system control unit 50 determines whether a conversion key that converts hiragana into katakana or kanji is pressed (step S512). One of the operation members 70 may be used as the conversion key. Alternatively, the conversion key may be arranged in the virtual keyboard 303.

In the example shown in FIG. 11, when the user operates the conversion key (YES in the step S513), the system control unit 50 coverts the hiragana string “ku-ri-su-ma-su” into the corresponding katakana string. That is, the system control unit 50 selects katakana or kanji according to the operation of the conversion key, and decides the character string (step S513).

It should be noted that one of the operation members 70 may be used as a backspace key that deletes one character. Alternatively, the backspace key may be arranged in the virtual keyboard 303.

When the conversion key has not been operated (NO in the step S512), the system control unit 50 returns the process to the step 505.

After the process in the step 5513 is completed, the system control unit 50 determines whether a character edit completion key has been operated (step S514). When the character edit completion key has not been operated (NO in the step S514), the system control unit 50 returns the process to the step 505.

On the other hand, when the character edit completion key has been operated (YES in the step S514), the system control unit 50 fixes the edited characters (step S515), and finishes the character input process.

One of the operation members 70 may be used as the character edit completion key. Alternatively, the character edit completion key may be arranged in the virtual keyboard 303.

Although the camera of the embodiment displays the left hand 301 by trimming from the image data on the display unit 28, the left hand 301 may be replaced with another image. In order to protect against an accident where a hand of another person suddenly comes in the shooting area in the character selection mode, only the fingers that are initially recognized after shifting to the character input mode are recognized as the indicators, and another finger is not recognized as the indicator.

According to the embodiment of the invention, the user can easily change the input mode among hiragana, alphabet, etc. by a single hand by changing the distance k from the camera to the hand.

As described in the above embodiment, the image pickup unit 22, the image processing unit 24, the system control unit 50, etc. in FIG. 2 function as the image pickup unit. The system control unit 50 functions as the distance measuring unit (distance measuring sensor), the display control unit, and the information inputting control unit. The operation members 70 and the system control unit 50 function as the threshold setting unit. For example, the nonvolatile memory 56 is the storage unit.

Although the embodiments of the invention have been described, the present invention is not limited to the above-mentioned embodiments, the present invention includes various modifications as long as the concept of the invention is not deviated.

For example, the functions of the above mentioned embodiments may be achieved as a control method that is executed by the information input device. Moreover, the functions of the above mentioned embodiments may be achieved as a control program that is executed by a computer with which the information input device is provided. It should be noted that the control program is recorded into a computer-readable storage medium, for example.

In this case, each of the control method and the control program has the shooting step, the distance measuring step, the display control step, and the information input control step at least.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-120342, filed on May 30, 2011, which is hereby incorporated by reference herein in its entirety.

What is claimed is:

1. An information input device for inputting information using a virtual item displayed on a display unit, comprising:
an image pickup unit configured to shoot an indicator that operates the virtual item continuously to obtain indicator image data;
a display control unit configured to display an indicator image corresponding to the indicator image data on the display unit; and
a setting unit configured to set, when detecting an action of the indicator to an element included in the virtual item displayed on the display unit, information corresponding to the element concerned as input information.

2. The information input device according to claim 1, further comprising:
a distance measuring unit configured to detect a distance between the indicator and said image pickup unit to obtain a detected distance;
a selection unit configured to select a virtual item based on the detected distance; and
a display control unit configured to display the virtual item selected by said selection unit and the indicator image corresponding to the indicator image data on the display unit.

3. The information input device according to claim 2, further comprising:
a threshold setting unit configured to set up at least one threshold value according to the distance between the indicator and said image pickup unit as a set threshold value; and
a storage unit configured to store a plurality of area ranges specified according to the distance between the indicator and said image pickup unit,
wherein said display control unit displays two types of the virtual items on the display unit when determining that the detected distance is included in the area range in which the set threshold value belongs.

4. The information input device according to claim 3, wherein said display control unit changes transmittances of the two types of the virtual items in opposite directions as the detected distance varies when displaying the two types of the virtual items.

5. The information input device according to claim 4, wherein said display control unit makes the transmittances of the two types of the virtual items be equal when the detected distance is equal to the set threshold value.

6. The information input device according to claim 4, wherein said display control unit sets the transmittance of one of the two types of the virtual items to 0% and does not display the other virtual item when the detected distance is equal to a boundary value of the area range in which the set threshold value belongs, and increases the transmittance of one of the two types of the virtual items and decreases the transmittance of the other virtual item as the detected distance increases within the area range in which the set threshold value belongs.

7. The information input device according to claim 1, wherein the virtual item is a virtual keyboard for inputting a character as information.

8. The information input device according to claim 1, wherein said display control unit displays the element of the virtual item that becomes a target of the predetermined operation by the indicator in distinction from other elements.

9. The information input device according to claim 1, wherein the indicator is a finger, and said setting unit sets up the input information corresponding to the element of the virtual item according to the shape of the finger.

10. A control method for an information input device for inputting information using a virtual item displayed on a display unit, the control method comprising:
a shooting step of shooting an indicator that operates the virtual item continuously by an image pickup unit to obtain indicator image data;
a display control step of displaying an indicator image corresponding to the indicator image data on the display unit; and
a setting step of setting, when detecting an action of the indicator to an element included in the virtual item displayed on the display unit, information corresponding to the element concerned as input information.

11. A non-transitory computer-readable storage medium storing a control program causing a computer to execute a control method for an information input device for inputting information using a virtual item displayed on a display unit, the control method comprising:
a shooting step of shooting an indicator that operates the virtual item continuously by an image pickup unit to obtain indicator image data;
a display control step of displaying an indicator image corresponding to the indicator image data on the display unit; and
a setting step of setting, when detecting an action of the indicator to an element included in the virtual item displayed on the display unit, information corresponding to the element concerned as input information.
